(19) United States
(12) Patent Application Publication
(10) Pub. No.: US 2015/0172649 A1
(43) Pub. Date: Jun. 18, 2015

(54) DISPLAY DEVICE, CALIBRATION DEVICE AND CONTROL METHOD THEREOF

(71) Applicant: SAMSUNG ELECTRONICS CO., LTD., Suwon-si (KR)

(72) Inventors: Min-jung KIM, Seoul (KR); Ji-yong PARK, Suwon-si (KR)

(73) Assignee: SAMSUNG ELECTRONICS CO., LTD., Suwon-si (KR)

(21) Appl. No.: 14/328,845

(22) Filed: Jul. 11, 2014

(30) Foreign Application Priority Data
Dec. 13, 2013 (KR) 10-2013-0155250

(51) Int. Cl. H04N 17/02

(52) U.S. Cl. CPC H04N 17/02

(57) ABSTRACT

A display device includes an image processor configured to process an image; a display configured to display the processed image; and a controller configured to determine that calibration information that is closer to a target value than to a characteristic value of the image exists, and to perform a first calibration with respect to the image based on the calibration information.

### CROSS-REFERENCE TO RELATED APPLICATION

This application claims priority from Korean Patent Application No. 10-2013-0155250, filed on Dec. 13, 2013 in the Korean Intellectual Property Office, the disclosure of which is incorporated herein by reference in its entirety.

### BACKGROUND

1. Field

Apparatuses and methods consistent with exemplary embodiments relate to calibrating the image based on the calibration information closer to the target value than to the characteristic value of the image, to thereby reduce the calibration time.

2. Description of the Related Art

When using a display device for viewing an image, users generally just accept the setting value of images set by a manufacturer, or make minor calibration to the setting value. However, because the users wish to set a desired image quality more professionally, the calibration function has been introduced to various types of display devices. Thus, users who use a display device such as a monitor, a broadcast television (TV), a large format display (LFD), a medical display, etc., may use the calibration function to obtain a desired color sense.

However, in the related art, the users perform the calibration function with respect to various setting values rather than one setting value, and, thus, calibration takes a great amount of time.

### SUMMARY

Exemplary embodiments may address at least the above problems and/or disadvantages and other disadvantages not described above. Also, the exemplary embodiments are not required to overcome the disadvantages described above, and may not overcome any of the problems described above.

Accordingly, one or more exemplary embodiments provide a display device, a calibration device and a control method thereof configured to determine existence or non-existence of calibration information that is closer to a target value than to a characteristic value of an image, and to calibrate the image based on the calibration information closer to the target value than to the characteristic value of the image if it is determined that there is such calibration information.

According to an aspect of an exemplary embodiment, there is provided a display device including: an image processor configured to process an image; a display configured to display the processed image; and a controller configured to determine that calibration information that is closer to a target value than to a characteristic value of the image exists, and to perform a first calibration with respect to the image based on the calibration information.

The controller may perform a second calibration with respect to the image to cause the characteristic value to reach the target value when it is determined that the characteristic value of the image, to which the first calibration has been performed, is not equal to the target value.

The display device further may include an optical characteristic measurer configured to measure the characteristic value of the image that is displayed on the display, wherein the controller performs a second calibration with respect to the image, to which the first calibration has been performed, to cause a difference between the characteristic value measured by the optical characteristic measurer and the target value to be within a predetermined range.

The controller may store the calibration information that has been obtained through the second calibration.

The display device further may include a user interface (UI) generator configured to generate a UI to calibration the image, wherein the controller controls the UI generator to generate the UI to display at least one of the characteristic value and the target value of the image, and comparison information of the characteristic value and the target value of the image.

According to an aspect of an exemplary embodiment, there is provided a control method including: determining that calibration information that is closer to a target value than to a characteristic value of an image exists; and performing a first calibration with respect to the image based on the calibration information that is closer to the target value than to the characteristic value of the image.

The control method further may include performing a second calibration to cause the characteristic value of the image to reach the target value when it is determined that the characteristic value of the image, to which the first calibration has been performed, is not equal to the target value.

The control method further may include measuring the characteristic value of the image to which the first calibration has been performed; and performing a second calibration with respect to the image, to which the first calibration has been performed, to cause a difference between the measured characteristic value and the target value to be within a predetermined range.

The control method further may include storing the calibration information that has been obtained through the second calibration.

The control method further may include generating a user interface (UI) configured to display at least one of the characteristic value and the target value of the image, and comparison information of the characteristic value and the target value of the image.

According to an aspect of an exemplary embodiment, there is provided a calibration device including: a storage configured to store calibration information regarding calibration of an image; and a controller configured to determine that the calibration information that is closer to a target value than to a characteristic value of the image exists, and to control a display device to perform a first calibration with respect to the image based on the calibration information closer to the target value.

The controller may control the display device to perform a second calibration to cause the characteristic value of the image to reach the target value when it is determined that the characteristic value of the image, to which the first calibration has been performed, is not equal to the target value.

The controller may control the display device to perform a second calibration with respect to the image, to which the first calibration has been performed, to cause a difference between a characteristic value measured by the display device and the target value to be within a predetermined range.

The controller may receive the calibration information that has been obtained through the second calibration performed with respect to the image, from the display device, and stores the received calibration information.

The controller may control the display device to generate a user interface (UI) configured to display at least one of the characteristic value and the target value of the image, and comparison information of the characteristic value and the target value of the image.

According to an aspect of an exemplary embodiment, there is provided a control method including: determining that calibration information that is closer to a target value than to a characteristic value of an image exists; and controlling a display device to perform a first calibration with respect to the image based on the calibration information that is closer to the target value than to the characteristic value of the image.

The controlling the display device further may include controlling the display device to perform a second calibration with respect to the image to cause the characteristic value of the image to reach the target value when it is determined that the characteristic value of the image, to which the first calibration has been performed, is not equal to the target value.

The control method further may include controlling the display device to perform the second calibration with respect to the image, to which the first calibration has been performed, to cause a difference between a characteristic value measured by the display device and the target value to be within a predetermined range.

The control method further may include the calibration information that has been obtained through the second calibration and storing the received calibration information.

The control method further may include controlling the display device to generate a user interface (UI) configured to display at least one of the characteristic value and the target value of the image, and comparison information of the characteristic value and the target value of the image.

### BRIEF DESCRIPTION OF THE DRAWINGS

The above and/or other aspects will become more apparent by describing certain exemplary embodiments with reference to the accompanying drawings, in which:

FIG. 1 is a block diagram of a display device according to an exemplary embodiment;

FIG. 2 is a block diagram of a display device according to an exemplary embodiment;

FIGS. 3 and 4 illustrate examples of calibration setting screens of the display device according to an exemplary embodiment;

FIG. 5 is a control flowchart showing operations of the display device according to an exemplary embodiment;

FIG. 6 is a control flowchart showing operations of the display device according to an exemplary embodiment;

FIG. 7 is a control flowchart showing operations of storing calibration information of an image in the display device according to an exemplary embodiment;

FIG. 8 is a block diagram of a calibration device according to an exemplary embodiment;

FIG. 9 is a block diagram of a calibration device according to an exemplary embodiment;

FIG. 10 is a control flowchart showing operations of the calibration device according to an exemplary embodiment;

FIG. 11 is a control flowchart showing operations of the calibration device according to an exemplary embodiment;

FIG. 12 is a control flowchart showing operations of storing calibration information of an image in the calibration device according to an exemplary embodiment; and

FIG. 13 illustrates an example of performing calibration according to an exemplary embodiment.

### DETAILED DESCRIPTION OF EXEMPLARY EMBODIMENTS

Exemplary embodiments are described in greater detail with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

A display device and a calibration device according to an exemplary embodiment calibrate an image, and store calibration information as a calibration result. If a user intends to calibrate another image, the display device and the calibration device calibrate another image by applying the stored calibration information that is closer to a target value than to a characteristic value of the current image. Unlike a normal calibration process, the calibration that is performed by applying the stored calibration information applies such calibration information as calibration result and thus rarely takes long time. If calibration is performed regarding the characteristic value and the target value of the image after the application of the stored calibration information, entire calibration time is reduced.

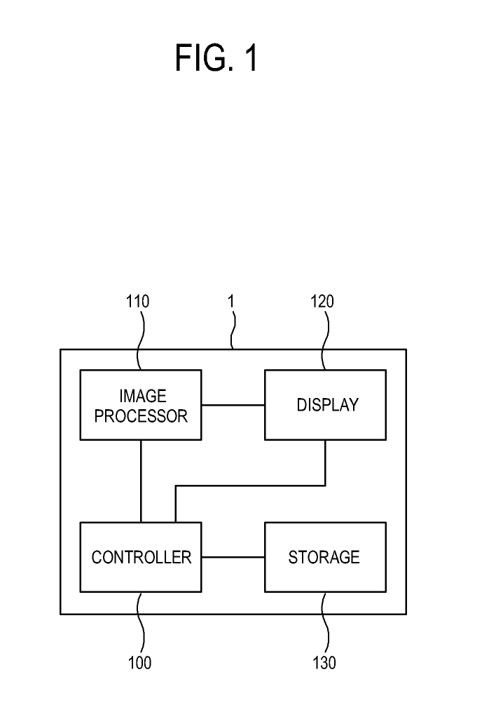

FIG. 1 is a block diagram of the display device 1 according to an exemplary embodiment. The display device 1 according to an exemplary embodiment may include an image processor 110, a display 120, and a controller 100.

The type of the image processing operation performed by the image processor 110 may include, without limitation, de-multiplexing for dividing a predetermined signal into signals by nature; decoding corresponding to an image format of image signals; de-interlacing for converting interlace image signals into progressive image signals; noise reduction for improving image quality; detail enhancement; frame refresh rate conversion, etc. The image processor 110 may include a decoder (not shown) to decode a source image corresponding to an image format of an encoded source image, and a frame buffer (not shown) to store a decoded source image by frame.

The image processor 110 may include a system-on-chip (SOC) which integrally performs the foregoing functions, or as an image processing board (not shown) that is formed by installing individual elements in a printed circuit board (PCB) and that is installed in the display device 1 to perform the foregoing functions independently.

The image processor 110 processes a broadcast signal including an image signal that is received by an image receiver (not shown) and a source image including an image signal supplied by an image supply source (not shown) according to preset various image processing operations. The image processor 110 may output the processed image signal to the display device 1 to display the processed source image in the display device 1.

The display 120 may display an image based on an image signal that is output by the image processor 110. The display 120 may include various displays including, without limitation, liquid crystal display (LCD), plasma display (PD), light-emitting diode (LED) display, organic light-emitting diode (OLED) display, surface-conduction electron-emitter (SED) display, carbon nanotube (CNT) display, and nanocrystal display.

The display 120 may further include additional elements depending on its embodiment type. For example, the display 120 may include an LCD panel, a PD panel or an OLED panel, for respective types of display implementations. Further, the display 120 may include a backlight unit (not shown) for emitting light to the display panel and a driving substrate (not shown) for driving the display panel.

The display 120 displays an image based on an image signal processed by the image processor 110.

The display 120 may display an image and a color correction process. The display 120 may include a display panel to display an image and a panel driver to process an input image signal to display an image on the display panel based on the processed image signal, but not limited thereto. An image signal that is provided by an external input source through an interface may be decoded, de-interlaced, and scaled to be displayed by the display 120. If the controller 100 that will be described later performs color correction according to a user's command, the display 120 may display a color correction process including a color patch and a color correction status window.

The controller 100 may determine existence or non-existence of calibration information that is closer to a target value than to a characteristic value of an image, and if it is determined that is the calibration information closer to the target value than to the characteristic value of the image, may calibrate the image based on the calibration information closer to the target value of the image.

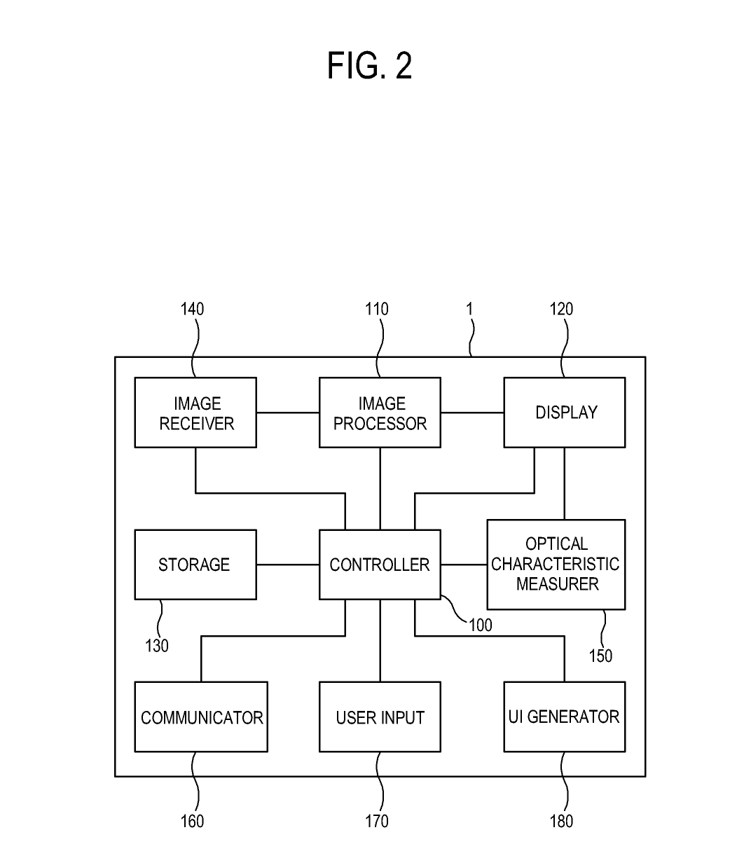

FIG. 2 is a block diagram of a display device 1 according to an exemplary embodiment. The display device 1 according to an exemplary embodiment may include the elements shown in FIG. 1, and may further include a storage 130, an image receiver 140, an optical characteristic measurer 150, a communicator 160, a user input 170 and a user interface (UI) generator 180.

The storage 130 may include a writable ROM in which data remain even upon cutoff of power to the display device 1, and in which any change may be reflected in respect of a user. The storage 130 may include at least one of a flash memory, an erasable programmable read only memory (EPROM) and an electrically erasable programmable read only memory (EEPROM). The storage 130 may store calibration information regarding calibration of an image.

The image receiver 140 may receive image signals/image data in a wired/wireless manner and transmit the image signals/image data to the image processor 110. The image receiver 140 may receive broadcast signals as image signals from a broadcast signal transmission device (not shown), receive image signals from imaging devices such as a digital versatile disc (DVD) player or a blu-ray disc (BD) player, receive image signals from a personal computer (PC), receive image signals from a mobile device such as a smart phone or a smart pad, receive image signals through a network such as the Internet or receive image contents as image signals stored in a storage medium such as a universal serial bus (USB) stick. In another exemplary embodiment, image signals may be stored in advance in the storage 130 rather than received through the image receiver 140. The image receiver 140 may be provided in various manners corresponding to a standard of a received image signal and an embodiment type of the display device 1. For example, the image receiver 140 may receive a radio frequency (RF) signal, or receive image signals according to standards such as composite video, component video, super video, SCART, high definition multimedia interface (HDMI), DisplayPort, unified display interface (UDI), or wireless HD. If an image signal is a broadcast signal, the image receiver 140 may include a tuner to tune the broadcast signal by channel.

The optical characteristic measurer 150 may include a calibration sensor to measure optical characteristics of an image. The optical characteristic measurer 150 may be included as a sensor in the display 120, or may be a camera that is attached to or aimed to the display 120. For example, the optical characteristic measurer 150 may be a smart phone, and may obtain optical characteristic information through an application function by using a camera of the smart phone, and transmit a photographed image to the controller 100 to calculate a characteristic value of the image. Otherwise, the optical characteristic measurer 150 may use a camera or a wireless transmitter to obtain optical characteristic information, i.e., a characteristic value of an image.

The communicator 160 may receive a signal from an external input and transmit the signal to the image processor 110 or the controller 100. The communicator 160 may receive a signal from an external input through various external input cables in a wired manner, and may receive a wireless signal according to a predetermined wireless communication standard.

The communicator 160 may include a plurality of connectors (not shown) to which respective cables are individually connected. The communicator 160 may receive signals from a connected external input, e.g., receive broadcast signals, image signals and data signals according to standards such as HDMI, USB or component, or receive communication data through a communication network.

The communicator 160 may further include various additional elements such as a wireless communication module (not shown) for wireless communication or a tuner (not shown) to tune a broadcast signal depending on a design type of the display device 1 and other elements to receive signals and/or data from an external input. The communicator 160 may transmit information, data, and/or signals of the display device 1 to an external device and receive signals from an external device. The communicator 160 is not limited to the element for receiving signals from an external input, and may include an interface for interactive communication. The communicator 160 may receive a control signal from a plurality of control devices to select a user interface (UI). The communicator 160 may include a communication module for near field communication such as Bluetooth, infrared (IR), ultra wideband (UWB) or Zigbee, or a communication port for wired communication. The communicator 160 may be used for various purposes such as transmission and reception of commands for manipulating displays and transmission and reception of data and/or control signals for selecting a UI.

The user input 170 may transmit preset various control commands or information to the controller 100 according to a user's manipulation and input. The user input 170 may include a menu key or an input panel that is installed in an external side of the display device 1, or a remote controller that is physically separated or spaced apart from the display device 1. Otherwise, the user input 170 may be integrally formed in the display 120. If the display 120 is a touch screen, a user may touch an input menu (not shown) displayed on the display 120, and a preset command may be transmitted to the controller 100.

The user input 170 may receive user's motion and voice. A user's motion may include a touch input. The user input 170 may directly receive user's motion and voice, or receive information of user's motion and voice from an external device.

The UI generator 180 may generate a UI for executing an application program. The generated UI may include a plurality of sub UIs that is provided in the form of icons and texts. If a user selects a particular sub UI through the display device 1, an application program may be executed corresponding to the selected sub UI. The respective sub UIs may be generated for a plurality of functions or events for executing the application program in the display device 1.

The UI generator 180 may include software or hardware functions for generating and controlling a UI displayed on the display 120, and such functions may be performed through the controller 100. That is, the UI generator 180 is not necessarily implemented as an additional chipset or an additional microprocessor. The UI generator 180 may generate a UI for calibrating an image.

The controller 100 may perform a first calibration with respect to an image by applying the calibration information, and if it is determined that a characteristic value of the image, to which the first calibration has been performed, is not equal to the target value, may perform a second calibration with respect to the image to cause the characteristic value to reach the target value. If it is determined that calibration information is not closer to the target value than to the characteristic value of a second image, the controller 100 may perform the second calibration rather than the first calibration to cause a characteristic value of the second image to reach a target value.

The controller 100 may perform a second calibration with respect to the image, to which the first calibration has been performed by applying the calibration information, to cause a difference between a characteristic value of the image measured by the optical characteristic measurer 150 and the target value to be within a predetermined range. The controller 100 may calibrate the image to cause the characteristic value to be equal to the target value or to be within a predetermined range of the target value. If the characteristic value of the image is within the predetermined range of the target value, the controller 100 may display the image, to which the second calibration has been performed, on the display 120, and may control the UI generator 180 to display a UI for a user to select resetting of the target value or completion of calibration.

The controller 100 may store calibration information that has been obtained through the second calibration performed with respect to the image. The controller 100 may store all calibration information obtained through calibration, in the storage 130.

The controller 100 may control the UI generator 180 to generate a UI for displaying at least one of a characteristic value and a target value of an image and comparison information of a characteristic value and a target value of an image. A user may be a professional, and the controller 100 may compare a characteristic value of an image for calibration, a characteristic value of a calibrated image and a measured characteristic value of a calibrated image and target value, and may provide a user with a comparison table, etc.

The controller 100 may use calibration information stored in the storage 130 or use calibration information stored in an external device (not shown) to calibrate an image. In addition, the controller 100 may transmit and store calibration information obtained through the second calibration, in an external device. For example, the controller 100 may store calibration information in an external device and perform calibration by using such calibration information.

Calibrating an image may include changing setting conditions displayed on the display 120 of the display device 1. Calibrating an image may also include calibrating an image and displaying the calibrated image. In an exemplary embodiment, calibrating an image may include changing setting conditions displayed in the display 120 to calibrate and display an image.

A calibration module may be provided separately from the controller 100 to change setting conditions of the display 120. The calibration module may otherwise be integrally provided in the controller 100 to calibrate an image.

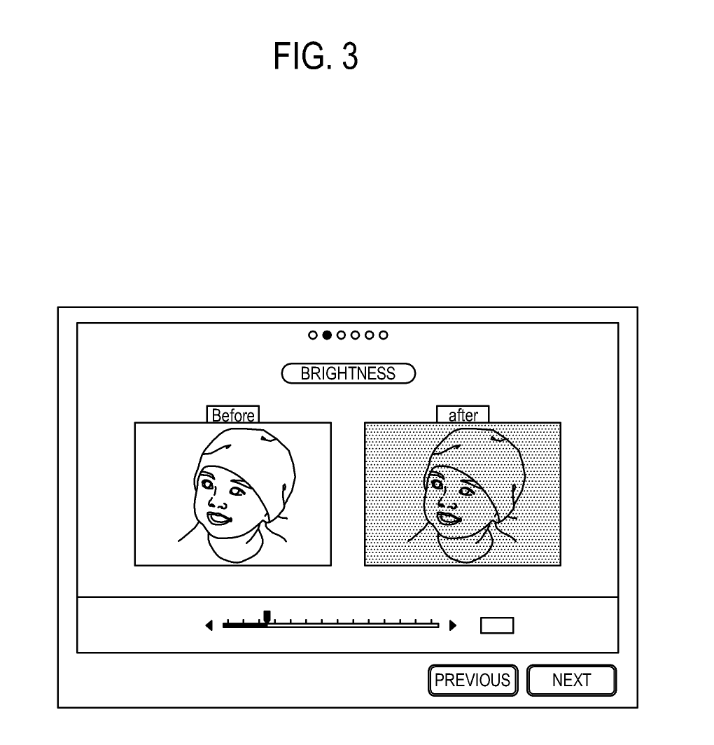

FIG. 3 illustrates an example of displaying a calibration setting screen by the display device 1 according to an exemplary embodiment.

There are many settings for calibrating an image. For example, setting conditions such as color gamut, brightness, black level, white point and RGB enhancement of the display 120 may be changed. FIG. 3 illustrates a setting screen showing a UI for setting a target value of brightness for calibration. As shown therein, a bar may be provided for a user to adjust the bar and calibrate brightness. FIG. 3 illustrates an example of a calibration setting item of an image so that even a non-professional may easily use the calibration setting item.

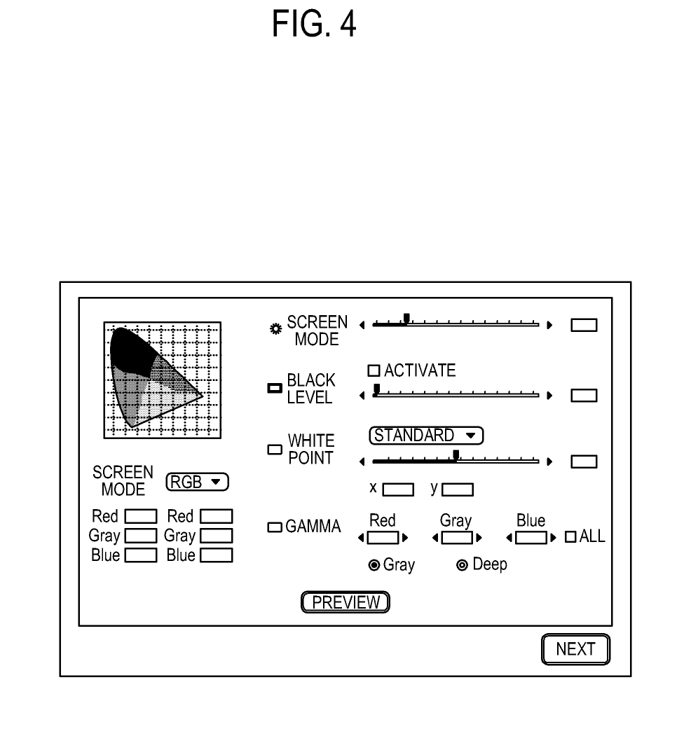

FIG. 4 illustrates an example of a calibration setting screen of the display device 1 according to an exemplary embodiment.

FIG. 4 illustrates the calibration setting item provided for a user to set such item for an image, but also illustrates a bar for setting a target value by professionals.

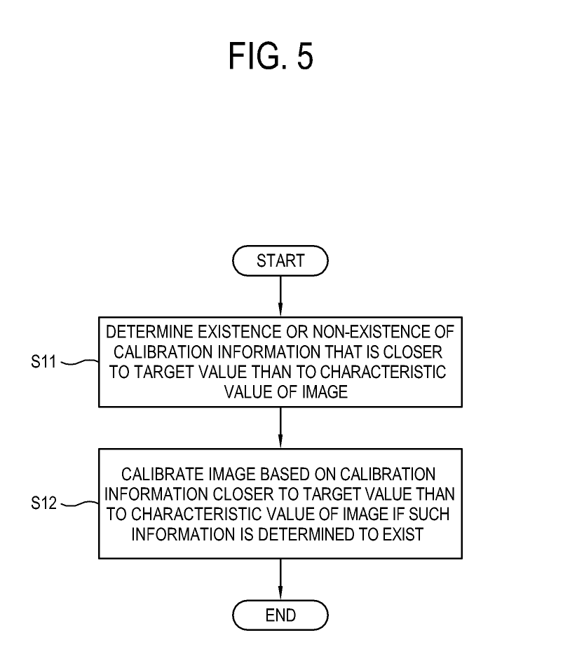

FIG. 5 is a control flowchart showing operations of the display device 1 according to an exemplary embodiment.

The existence or non-existence of calibration information that is closer to the target value than to the characteristic value of the image is determined (operation S11).

If it is determined that there is the calibration information that is closer to the target value than to the characteristic value of the image, the image is calibrated on the basis of the calibration information closer to the target value (operation S12). Calibrating the image may include applying the characteristic value of calibration result by applying the stored calibration information rather than performing calibration to the image.

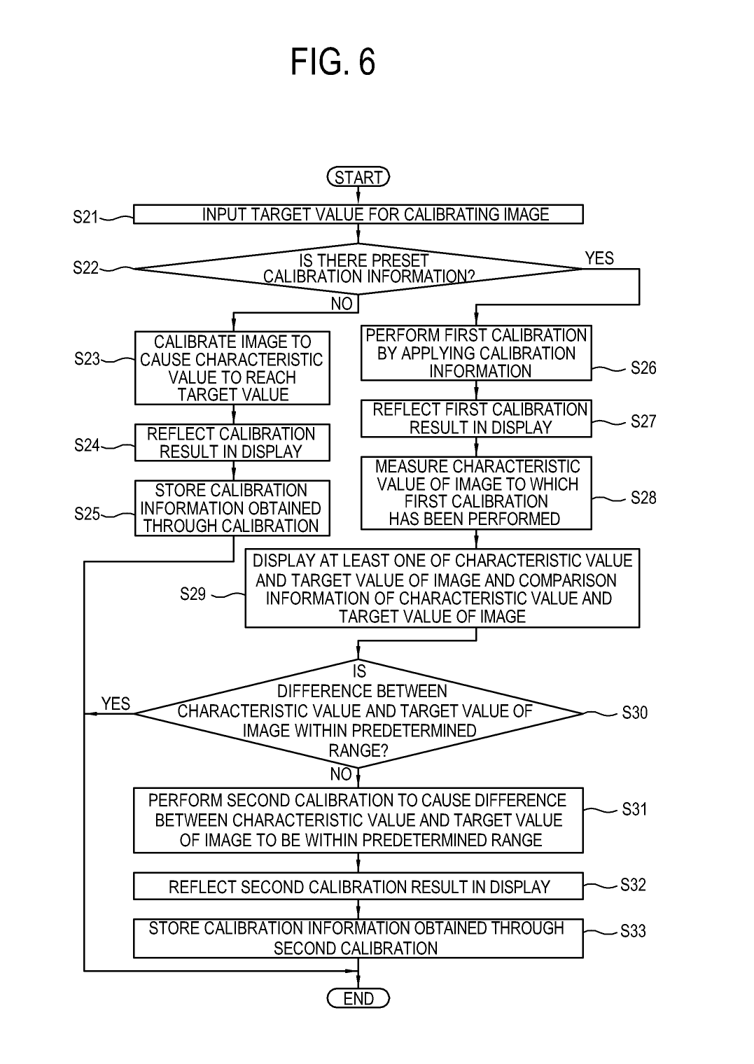

FIG. 6 is a control flowchart showing operations of the display device 1 according to an exemplary embodiment.

A user inputs a target value for calibrating an image (operation S21).

The controller 100 determines existence or non-existence of preset calibration information (operation S22). Determining existence or non-existence of the calibration information may be based on the contents stored in the storage 130 and/or in an external storage space.

If it is determined that there is no preset calibration information or no calibration information closer to the target value than to the characteristic value of the image, a normal calibration process is performed. The image is calibrated to cause the characteristic value of the image to reach the target value (operation S23).

The calibration result is reflected in the display 120, i.e., the settings of the display 120 (operation S24). Then, a user may view the image in which the calibration result has been reflected, on the display 120.

If a user inputs a completion command, the controller 100 stores the calibration information obtained through the calibration, in the storage 130 or in an external device, and completes the calibration (operation S25).

If the preset calibration information may be obtained at operation S22, the first calibration is performed with respect to the image by applying the calibration information that is closer to the target value than to the characteristic value of the image (operation S26).

The first calibration result is reflected in the display 120 (operation S27).

The characteristic value of the image, to which the first calibration has been performed, is measured from the display 120 (operation S28).

At least one of the measured characteristic value and the target value of the image and comparison information of the characteristic value and target value of the image is displayed on the display 120 (operation S29).

It is determined whether a difference between the measured characteristic value and the target value of the image is within the predetermined range (operation S30). The predetermined range may be set in advance by a user and stored, or may be set in advance by a manufacturer and a supplier of the display device 1.

If the difference between the measured characteristic value and the target value of the image is within the predetermined range, the calibration process is completed.

If the difference between the measured characteristic value and the target value of the image is not within the predetermined range at operation S30, the second calibration is performed with respect to the image to cause the difference to be within the predetermined range (operation S31).

The second calibration result is reflected in the display 120 (operation S32).

The calibration information that has been obtained through the second calibration is stored in the storage 130 or in an external device (operation S33). If more calibration information is obtained through the second calibration and stored in the storage 130, the calibration time may be further reduced.

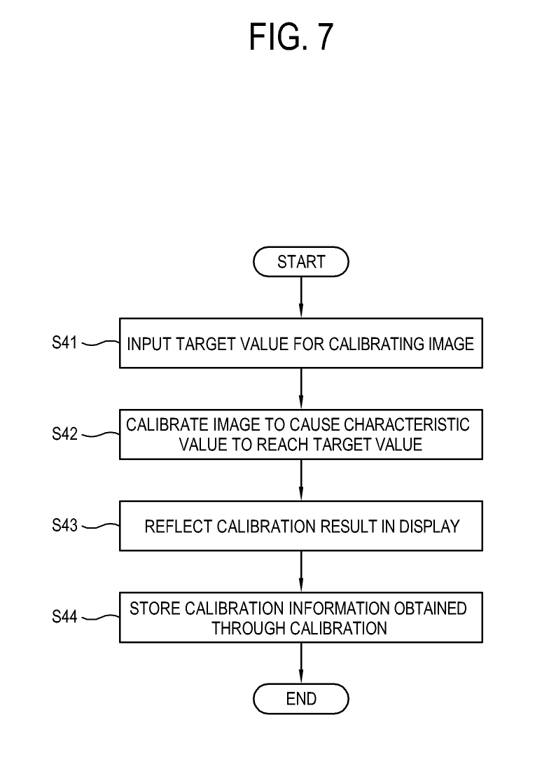

FIG. 7 is a control flowchart for storing calibration information of an image by the display device 1 according to an exemplary embodiment.

A user inputs a target value for calibrating an image (operation S41).

The image is calibrated to cause the characteristic value of the image to reach the target value (operation S42). The calibration performed at operation S42 includes displaying the image on the display 120 based on the calibration value, and measuring the characteristic value of the displayed image. The measured characteristic value is compared with the target value, and if the difference between the measured characteristic value and the target value is not within the predetermined range, the foregoing process is repeated until such difference is within the predetermined range.

The calibration result which is obtained by causing the characteristic value of the image to be within the predetermined range of the target value is reflected in the display 120 (operation S43).

The calibration information that has been obtained through the calibration is stored in the storage 130 or in an external device (operation S44).

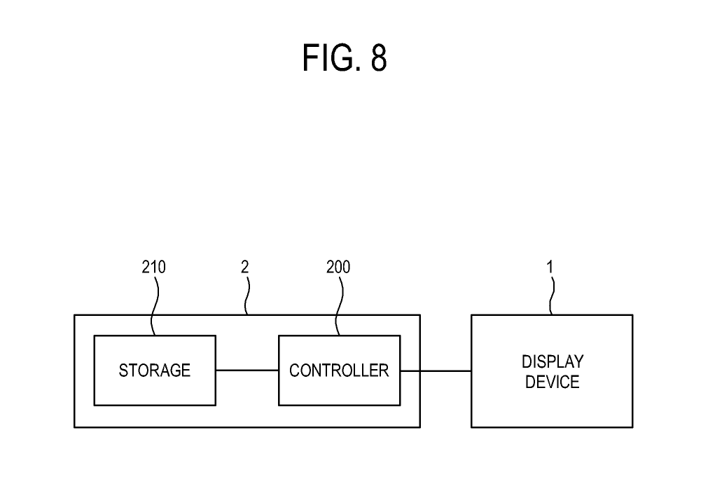

FIG. 8 is a block diagram of a calibration device 2 according to an exemplary embodiment. The calibration device 2 according to an exemplary embodiment may include a storage 210 and a controller 200. The calibration device 2 may be connected to the display device 1 and control calibration of an image that is displayed by the display device 1, and may include a personal computer (PC), a laptop computer or a user terminal. The calibration device 2 including a PC according to an exemplary embodiment may control the calibration performed by the display device 1. The configuration of the calibration device 2 is substantially the same as the configuration of the display device 1 and thus description will be omitted.

The controller 200 may determine existence or non-existence of calibration information that is closer to a target value than to a characteristic value of an image. If it is determined that there is the calibration information closer to the target value than to the characteristic value of the image, the controller 200 may control the display device 1 to calibrate the image based on such calibration information.

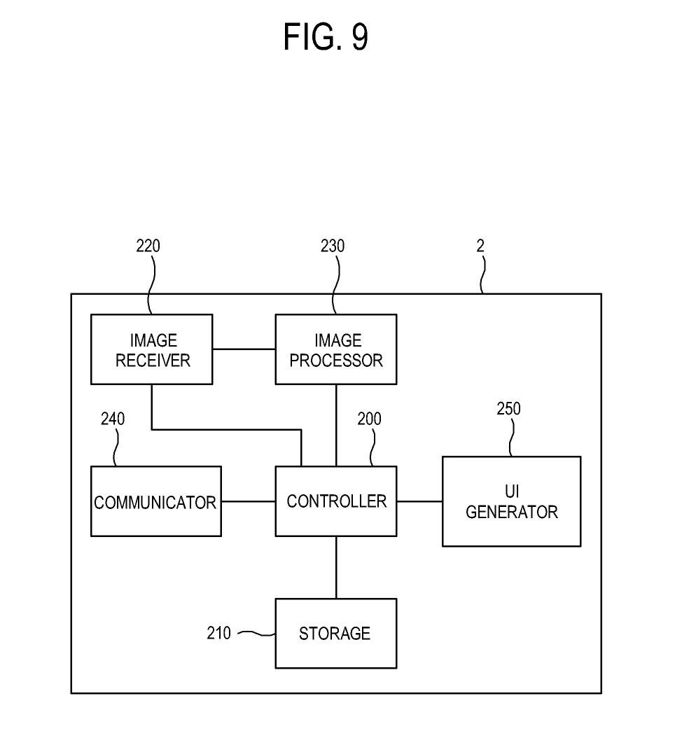

FIG. 9 is a block diagram of a calibration device 2 according to an exemplary embodiment. The calibration device 2 according to an exemplary embodiment may include the elements shown in FIG. 8, and may further include an image receiver 220, an image processor 230, a communicator 240 and a UI generator 250. With respect to the elements of the calibration device 2 which are substantially the same as those of the display device 1, the explanation of the display device 1 will be referred to, and the explanation of the elements of the calibration device 2 except for the controller 200 will be omitted.

The controller 200 performs a first calibration with respect to an image by applying calibration information. If it is determined that a characteristic value of the image, to which the first calibration has been performed, is not equal to a target value, the controller 200 may control the display device 1 to perform a second calibration to cause the characteristic value of the image to reach the target value.

The controller 200 may control the display device 1 to perform the second calibration with respect to the image, to which the first calibration has been performed, by applying the calibration information, to cause a difference between a characteristic value measured by the display device 1 and the target value to be within a predetermined range.

The controller 200 may receive calibration information obtained through the second calibration performed to the image, from the display device 1 and store the received calibration information.

The controller 200 may control the display device 1 to generate a UI to display at least one of a characteristic value and a target value of an image, and comparison information of a characteristic value and a target value of an image.

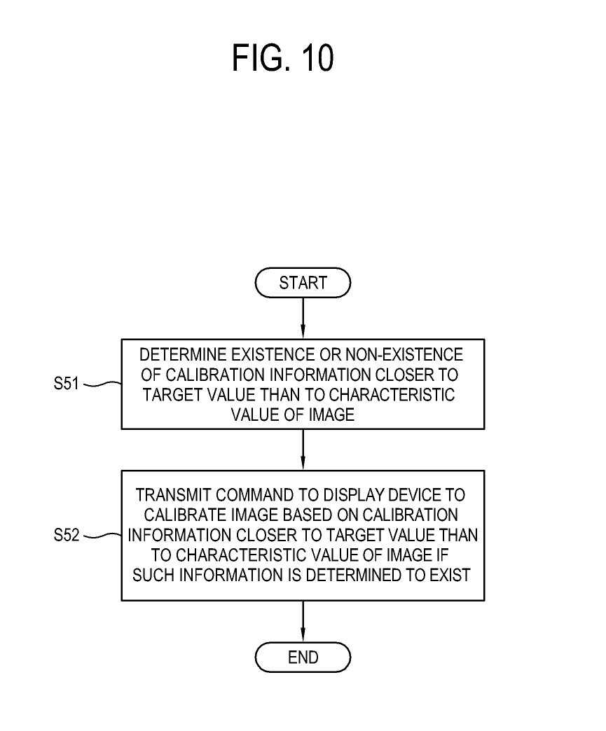

FIG. 10 is a control flowchart showing operations of the calibration device 2 according to an exemplary embodiment.

The existence or non-existence of calibration information that is closer to the target value than to the characteristic value of the image is determined (operation S51).

If it is determined that there is the calibration information that is closer to the target value than to the characteristic value of the image, a command is transmitted to the display device 1 to calibrate the image on the basis of the calibration information closer to the target value (operation S52). Calibrating the image may include applying the characteristic value of calibration result by applying the stored calibration information rather than performing calibration to the image.

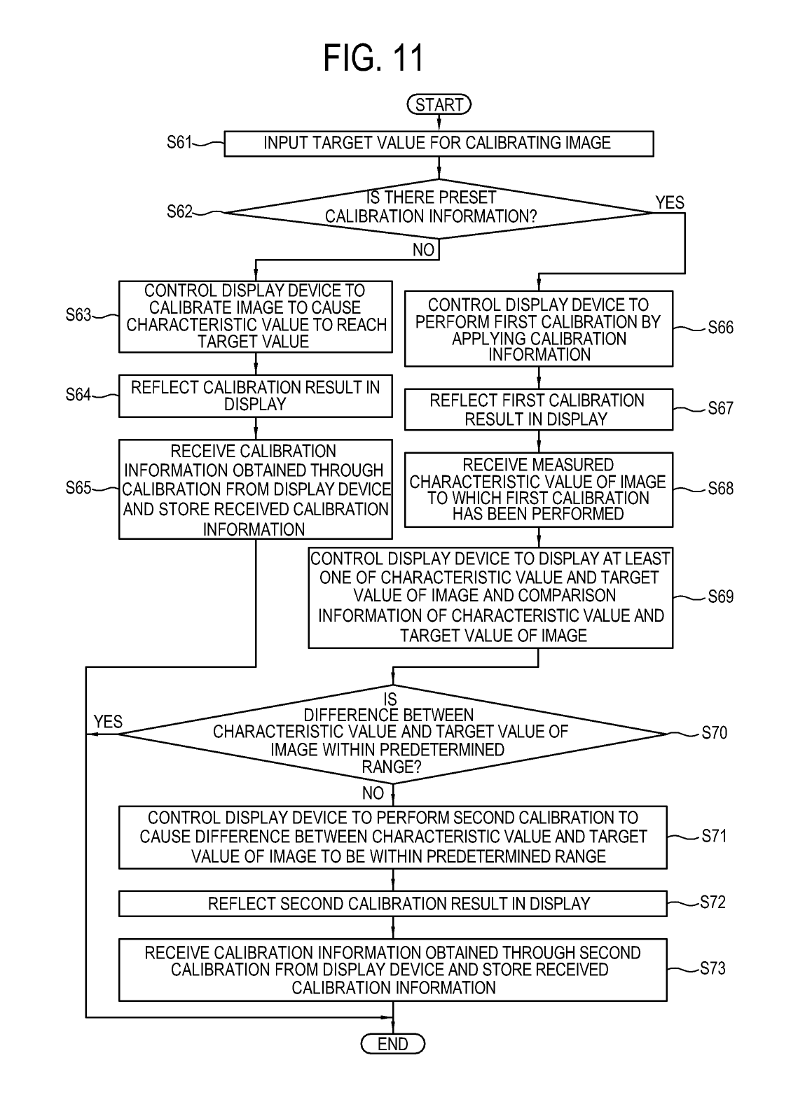

FIG. 11 is a control flowchart showing operations of the calibration device 2 according to an exemplary embodiment.

A user inputs a target value for calibrating an image (operation S61).

The controller 200 determines existence or non-existence of preset calibration information (operation S62). Determining existence or non-existence of the calibration information may be based on the contents stored in the storage 130 and/or in an external storage space.

If it is determined that there is no preset calibration information or no calibration information closer to the target value than to the characteristic value of the image, a command is transmitted to the display device 1 to perform a normal calibration process. That is, a command is transmitted to the display device 1 to calibrate the image to cause the characteristic value of the image to reach the target value (operation S63).

A command is transmitted to the display device 1 to reflect calibration result in the display device 1 (operation S64). Then, a user may view the image, in which the calibration result has been reflected, from the display device 1.

If a user inputs a completion command, the controller 200 receives calibration information obtained through the calibration from the display device 1, stores the received calibration information in the storage 210 or in an external device and completes the calibration process (operation S65).

If the preset calibration information may be obtained at operation S62, a command is transmitted to the display device 1 to perform the first calibration with respect to the image by applying the calibration information that is closer to the target value than to the characteristic value of the image (operation S66).

A command is transmitted to the display device 1 to reflect the first calibration result in the display device 1 (operation S67).

The measured characteristic value of the image, to which the first calibration has been performed, is transmitted by the display device 1 (operation S68).

A command is transmitted to the display device 1 to display at least one of the measured characteristic value and the target value of the image and comparison information of the characteristic value and the target value of the image (operation S69).

It is determined whether a difference between the measured characteristic value and the target value of the image is within the predetermined range (operation S70). The predetermined range may be set in advance by a user and stored, or may be set in advance by a manufacturer and a supplier of the display device 1.

If the difference between the measured characteristic value and the target value of the image is within the predetermined range, the calibration process is completed.

If the difference between the measured characteristic value and the target value of the image is not within the predetermined range at operation S70, a command is transmitted to the display device 1 to perform the second calibration with respect to the image to cause the difference to be within the predetermined range (operation S71).

A command is transmitted to the display device 1 to reflect the second calibration result in the display device 1 (operation S72).

The calibration information that has been obtained through the second calibration is transmitted by the display device 1 and is stored in the storage 210 or in an external device (operation S73). If more calibration information is obtained through the second calibration and stored in the storage 210, the calibration time may be further reduced.

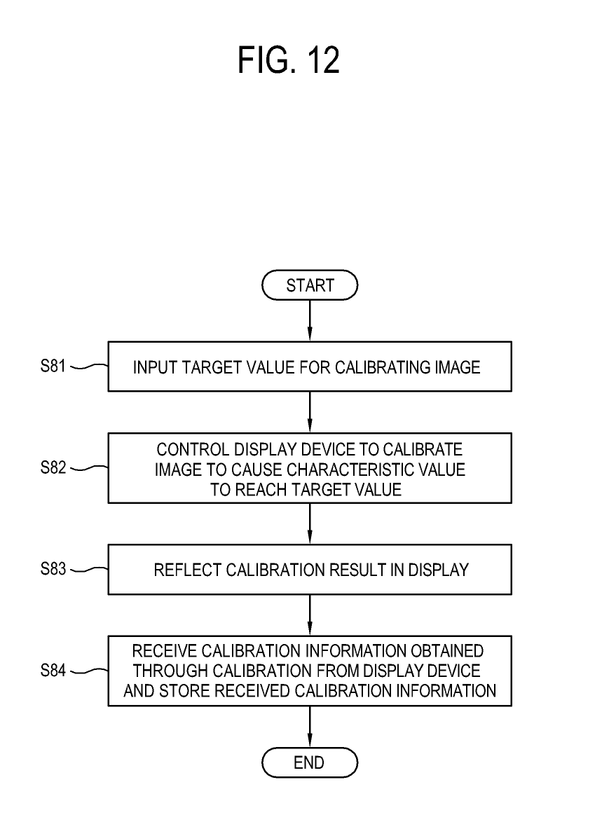

FIG. 12 is a control flowchart for storing calibration information of an image by the calibration device 2 according to an exemplary embodiment.

A user inputs a target value for calibrating an image (operation S81).

A command is transmitted to the display device 1 to calibrate the image and to cause the characteristic value of the image to reach the target value (operation S82). The calibration performed at operation S82 includes displaying the image in the display device 1 based on the calibration value, and controlling the display device 1 to measure optical characteristic of the displayed image. The measured characteristic value is compared with the target value, and if the difference between the measured characteristic value and the target value is not within the predetermined range, a calibration command is transmitted to the display device 1 to repeat the foregoing process until such difference is within the predetermined range.

A command is transmitted to the display device 1 to reflect in the display device 1 the calibration result which is obtained by causing the characteristic value of the image to be within the predetermined range of the target value (operation S83).

The calibration information that has been obtained through the calibration is transmitted by the display device 1 and stored in the storage 210 or in an external device (operation S84).

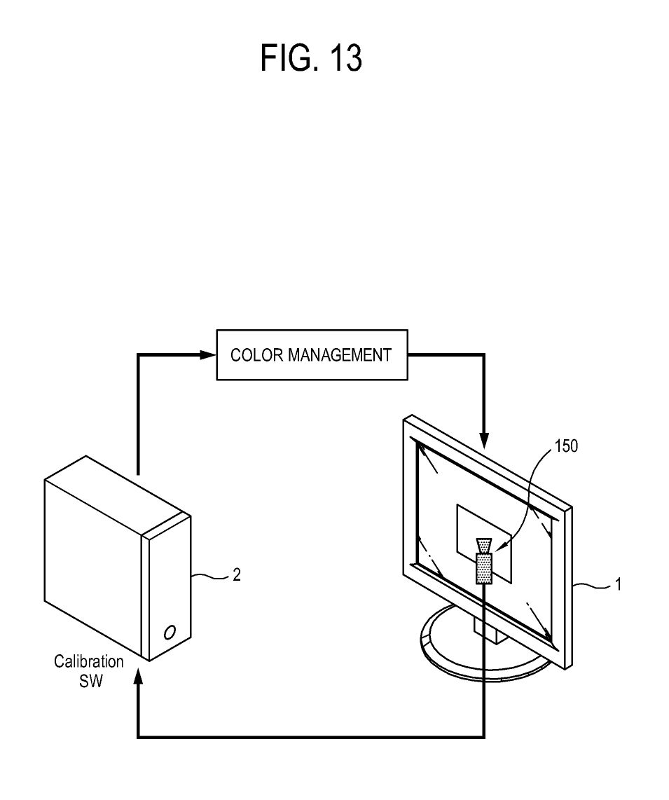

FIG. 13 illustrates an example of performing calibration according to an exemplary embodiment.

In FIG. 13, the optical characteristic measurer 150 of the display device 1 measures and transmits optical characteristics of an image to the calibration device 2 to control and manage calibration. The display device 1 and the calibration device 2 may be connected in a wired and/or wireless manner. Therefore, a user may calibrate an image by using a user terminal. Any device in which an application may be installed to perform calibration may be used.

As described above, the display device 1 and the calibration device 2 according to exemplary embodiments may store the calibration information obtained through the calibration performed with respect to the image, and may perform the same or similar calibration with respect to another image more quickly, and enhance a user's convenience, based on the stored calibration information.

A display device and a calibration device according to exemplary embodiments may determine existence or non-existence of calibration information that is closer to a target value than to a characteristic value of an image, and may perform the same or similar calibration with respect to another image more quickly and enhance a user's convenience, based on the stored calibration information.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display device comprising:
an image processor configured to process an image;
a display configured to display the processed image; and
a controller configured to determine that calibration information that is closer to a target value than to a characteristic value of the image exists, and to perform a first calibration with respect to the image based on the calibration information.

2. The display device of claim 1, wherein the controller performs a second calibration with respect to the image to cause the characteristic value to reach the target value when it is determined that the characteristic value of the image, to which the first calibration has been performed, is not equal to the target value.

3. The display device of claim 1, further comprising:
an optical characteristic measurer configured to measure the characteristic value of the image that is displayed on the display,
wherein the controller performs a second calibration with respect to the image, to which the first calibration has been performed, to cause a difference between the characteristic value measured by the optical characteristic measurer and the target value to be within a predetermined range.

4. The display device of claim 2, wherein the controller stores the calibration information that has been obtained through the second calibration.

5. The display device of claim 1, further comprising:
a user interface (UI) generator configured to generate a UI to calibration the image,
wherein the controller controls the UI generator to generate the UI to display at least one of the characteristic value and the target value of the image, and comparison information of the characteristic value and the target value of the image.

6. A control method comprising:
determining that calibration information that is closer to a target value than to a characteristic value of an image exists; and
performing a first calibration with respect to the image based on the calibration information that is closer to the target value than to the characteristic value of the image.

7. The control method of claim 6, further comprising:
performing a second calibration to cause the characteristic value of the image to reach the target value when it is determined that the characteristic value of the image, to which the first calibration has been performed, is not equal to the target value.

8. The control method of claim 6, further comprising:
measuring the characteristic value of the image to which the first calibration has been performed; and
performing a second calibration with respect to the image, to which the first calibration has been performed, to cause a difference between the measured characteristic value and the target value to be within a predetermined range.

9. The control method of claim 7, further comprising:
storing the calibration information that has been obtained through the second calibration.

10. The control method of claim 6, further comprising:
generating a user interface (UI) configured to display at least one of the characteristic value and the target value of the image, and comparison information of the characteristic value and the target value of the image.

11. A calibration device comprising:
a storage configured to store calibration information regarding calibration of an image; and
a controller configured to determine that the calibration information that is closer to a target value than to a characteristic value of the image exists, and to control a display device to perform a first calibration with respect to the image based on the calibration information closer to the target value.

12. The calibration device of claim 11, wherein the controller controls the display device to perform a second calibration to cause the characteristic value of the image to reach the target value when it is determined that the characteristic value of the image, to which the first calibration has been performed, is not equal to the target value.

13. The calibration device of claim 11, wherein the controller controls the display device to perform a second calibration with respect to the image, to which the first calibration has been performed, to cause a difference between a characteristic value measured by the display device and the target value to be within a predetermined range.

14. The calibration device of claim 12, wherein the controller receives the calibration information that has been obtained through the second calibration performed with respect to the image, from the display device, and stores the received calibration information.

15. The calibration device of claim 11, wherein the controller controls the display device to generate a user interface (UI) configured to display at least one of the characteristic value and the target value of the image, and comparison information of the characteristic value and the target value of the image.

16. A control method comprising:
determining that calibration information that is closer to a target value than to a characteristic value of an image exists; and
controlling a display device to perform a first calibration with respect to the image based on the calibration information that is closer to the target value than to the characteristic value of the image.

17. The control method of claim 16, wherein the controlling the display device further comprises:
controlling the display device to perform a second calibration with respect to the image to cause the characteristic value of the image to reach the target value when it is determined that the characteristic value of the image, to which the first calibration has been performed, is not equal to the target value.

18. The control method of claim 16, further comprising:
controlling the display device to perform the second calibration with respect to the image, to which the first calibration has been performed, to cause a difference between a characteristic value measured by the display device and the target value to be within a predetermined range.

19. The control method of claim 17, further comprising receiving the calibration information that has been obtained through the second calibration and storing the received calibration information.

20. The control method of claim 16, further comprising:
controlling the display device to generate a user interface (UI) configured to display at least one of the characteristic value and the target value of the image, and comparison information of the characteristic value and the target value of the image.
